(19) United States
(12) Patent Application Publication
(10) Pub. No.: US 2017/0253751 A1
(43) Pub. Date: Sep. 7, 2017

(54) 3D PRINTABLE COMPOSITE WATERBORNE DISPERSIONS

(71) Applicant: Voxel8, Inc., Somerville, MA (US)

(72) Inventors: Travis A. Busbee, Somerville, MA (US); Stephanie Marzen, Somerville, MA (US)

(21) Appl. No.: 15/411,528

(22) Filed: Jan. 20, 2017

Related U.S. Application Data
(60) Provisional application No. 62/286,067, filed on Jan. 22, 2016.

(51) Int. Cl. C09D 7/00; C09D 175/04; C09D 5/24; B29C 67/00; C09D 177/00; D06M 15/564; B33Y 70/00; B33Y 10/00; C09D 175/06; C09D 7/12

(52) U.S. Cl. CPC C09D 7/001; C09D 175/06; C09D 175/04; C09D 5/24; C09D 7/1216; C09D 7/1291; C09D 7/125; C09D 177/00; D06M 15/564; C09D 7/002; B33Y 70/00; B33Y 10/00; B29C 67/0081

(57) ABSTRACT

A composite waterborne dispersion for 3D printing. The dispersion includes a composition containing an aqueous dispersion of polymer particles; an associative thickener; and a functional filler. The functional filler may be conductive particles, fumed silica, milled glass fibers, polydimethylsiloxane, eutectic metal particles, carbon fiber, thermally insulating particles, thermally conductive particles, ferromagnetic particles, particles with high acoustic impedance, low-k dielectric particles, or high-k dielectric particles. The composition has a yield stress >0 Pa, the yield stress being at least one of dynamic yield stress and static yield stress. The composition is film-forming when dried. A method for three-dimensionally printing an object with a three-dimensional printer includes dispensing a composite waterborne dispersion to deposit the dispersion toward a build surface to define an object portion, the dispersion including an aqueous dispersion of polymer particles and an associative thickener, the composition having a yield stress >0 Pa and being film-forming when dried.

### RELATED APPLICATION

This application claims priority to U.S. Provisional Patent Application Ser. No. 62/286,067, filed Jan. 22, 2016, the entire contents of which are incorporated by reference herein.

### FIELD OF THE INVENTION

Embodiments of the invention relate to three-dimensional (“3D”) printable inks, based on composite waterborne polymer dispersions.

### BACKGROUND

The 3D printing industry currently faces limitations in the variety of materials that may be printed. Thermoplastic filaments are widely used in fused deposition modeling (“FDM”) and fused filament fabrication (“FFF”) printing, while UV curable resins are dominant in stereolithography (“SLA”) printing.

There is a commercial need for 3D printing of polymer-based inks in electronics, shoe manufacturing, and other industries.

### SUMMARY

In an aspect, embodiments of the invention relate to a composite waterborne dispersion for 3D printing. The composite waterborne dispersion includes a composition including a first aqueous dispersion of polymer particles, an associative thickener, and a first functional filler including conductive particles. The composition has a yield stress >0 Pa, the yield stress being at least one of a dynamic yield stress and a static yield stress. The composition is film-forming when dried.

One or more of the following features may be included. The composition may have a static yield stress >50 Pa, e.g., >200 Pa. The composition may have a viscosity selected from a range of 10 to 10,000 Pas at shear rate 1/s. The composition may include a non-volatile content selected from a range of 70 wt % to 95 wt %, or greater than 25 volume percent, preferably greater than 40 volume percent. The maximum agglomerate size of the composition may be less than 50 microns, or preferably less than 25 microns. The aqueous dispersion of polymer particles may be self-crosslinking at room temperature. The aqueous dispersion of polymer particles may have a minimum film formation temperature below 22° C. The aqueous dispersion of polymer particles may include at least one of a polyurethane, an acrylic, an alkyd, PVC, styrene butadiene, vinyl acetate, vinyl acetate ethylenes, vinyl maleate, or vinyl versatate. The associative thickener may be selected from the group including a hydrophobically modified ethoxylated urethane (HEUR), a hydrophobically modified alkali swellable emulsion (HASE), a tri-block co-polymer, a hydrophobically modified polyacrylate thickener, a hydrophobically modified polyether thickener, or a hydrophobically modified cellulose ether. The composite waterborne dispersion may include a solid metal precursor and/or a dissolved metal precursor.

The composition may further include a second functional filler. The second functional filler may include a color pigment, and the composition may include 0.1-10 wt % color pigment. The second functional filler may be selected from the group including conductive particles, fumed silica, milled glass fibers, PDMS, a eutectic metal particle, quartz, carbon fiber, thermally insulating particles, thermally conductive particles, ferromagnetic particles, or radar absorbing particles.

At least a portion of the second functional filler may include a coating material that interacts with the associative thickener. The coating material may be selected from the group including an unsaturated hydrocarbon, a fatty acid, an ionic surfactant, a nonionic surfactant, an ionic polymer, or a block copolymer.

The composition may include at least 25 wt % conductive particles. The conductive particles may be selected from the group including silver powder, silver flakes, silver nanowires, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, graphene, copper oxide particles, tungsten particles, aluminum microparticles, nickel microparticles, or microparticles of eutectic metal systems. An average diameter of the polymer particles in the aqueous dispersion may be at least one order of magnitude smaller than an average diameter of the conductive particles of the first functional filler.

The composition may further include a rheological modifier that increases a resting viscosity, yield stress, or pseudoplastic behavior of the composition.

The composition may further include at least one of a defoamer, an antifoam, a coalescent, a dispersant, or an adhesion modifier. The composition may include the defoamer and the defoamer is selected from the group including a silicone-based defoamer, an oil-based defoamer, a powder-based defoamer, a wax-based defoamer, polyethylene glycol-based defoamer, polypropylene glycol-based defoamer, an alkyl-polyacrylate based defoamer, an antifoam, PDMS, polyester-functionalized silicone, or fluorosilicone.

The composition may include a coalescent. The coalescent may be selected from the group including glycol ethers, (3-hydroxy-2,2,4-trimethylpentyl) 2-methylpropanoate (e.g., TEXANOL from Eastman), propylene carbonate, diethyl carbonate, N-Methyl-2-pyrrolidone (NMP), dimethyl formamide (DMF), tetrahydrofuran (THF), dibasic esters, glycols, glycol ether acetates, propylene glycol, ethylene glycol, 2,2,4-trimethyl-1,3-pentanediol diisobutyrate (e.g., OPTIFILM enhancer 300), OPTIFILM enhancer 400, 2-ethylhexyl benzoate (e.g., VELATE 368 Coalescent from Eastman), or 2,2,4-trimethyl-1,3-pentanediol diisobutyrate (e.g., VELATE 375 Coalescent from Eastman).

The composition may include the dispersant, and the dispersant may be selected from the group including sorbitan monooleate (e.g., SPAN 80 from Sigma-Aldrich), polyethylene glycol sorbitan monooleate (e.g., TWEEN 80 from Eastman), octylphenol ethoxylate (e.g., TRITON X-100 from Sigma-Aldrich), HYDROPALAT WE 3320 from BASF (Trade Secret: NJTSRN 489909-5554-PC; one component is a type of fatty alcohol alkoxylate), DAPRO W-77 from Elementis Specialties (contains ethylene glycol monobutyl ether, ethyl alcohol, and dioctyl sodium sulfosuccinate), JEFFSPERSE X3503 from Huntsman (proprietary blend of a nonionic polymeric dispersant), DISPERBYK 190 from Byk (solution of a high molecular weight block copolymer with pigment affinic groups), ZETASPERSE 3100 from Air Products (proprietary surface active polymers), RHODOLINE3500 from Solvay, DISPEX Ultra FA 4480 NU from BASF (modified fatty alcohol polyglycol ether), polyacrylic, ionic surfactants, non-ionic surfactants, or comb polymers.

The composition may include the adhesion modifier, and the adhesion modifier may be selected from the group including a silane coupling agent, a secondary polymer, a secondary polymer dispersion, a dissolved polymer, an oligomer, a surfactant, a wetting agent, a chlorinated polyolefins, an epoxy-functionalized compound, or an amino-functional silicone polymer. The adhesion modifier may include the silane coupling agent and the composition may include 0.01-3 wt % silane coupling agent. The adhesion modifier may include the silane coupling agent and the silane coupling agent may be selected from the group including glycidoxypropyltrimethoxysilane, aminopropyltriethoxysilane, aminoethylaminopropyl-trimethoxysilane, 3-methacryloxypropyltrimethoxysilane, cationic vinylbenzyl and amino-functional methoxy-silane, vinyltrimethoxysilane, or aminoethylaminopropyltrialkoxysilane.

The composition may include the adhesion modifier and the adhesion modifier may include at least two different types of silane coupling agents. The adhesion modifier may include a second aqueous dispersion of a second type of polymer particles. The polymer particles of the second aqueous dispersion may be compatible with the polymer particles of the first aqueous dispersion. The adhesion modifier may include a dissolved polymer. The dissolved polymer may be a cellulose derivative, which may be selected from the group including hydroxypropyl cellulose, hydroxyethyl cellulose, hydroxypropylmethyl cellulose, or sodium carboxy methyl cellulose. The dissolved polymer may be an ionic polymer, which may be selected from the group consisting of polyacrylic acid, alginate, xanthan gum, pectin, carrageenan, or hyaluronic acid. The dissolved polymer may be a nonionic polymer, which may be selected from the group including polyvinylpyrrolidone, polyethylene glycol, polyethylene oxide, dextran, guar gum, polyvinyl alcohol, polyacrylamide, or chitosan. The composition may cure or dry at room temperature.

An object may include the composite waterborne dispersion.

The description of elements of the embodiments of other aspects of the invention may be applied to this aspect of the invention as well.

In another aspect, embodiments of the invention relate to a method for three-dimensionally printing an object with a three-dimensional printer including a dispensing system including at least one cartridge adapted to dispense a composite waterborne dispersion through an orifice as a continuous filament, a build surface disposed below the dispensing system, or a robotic control system with at least one axis of movement. The method includes dispensing the composite waterborne dispersion from the cartridge through the orifice to deposit the waterborne dispersion toward the build surface to define at least a portion of the object. The composite waterborne dispersion includes a composition of an aqueous dispersion of polymer particles or associative thickener, and the composition has a yield stress >0 Pa, the yield stress being at least one of a dynamic yield stress and a static yield stress, and the composition is film-forming when dried.

One or more of the following features may be included. The composition may further include a functional filler, which may be selected from the group including a color pigment, conductive particles, fumed silica, milled glass fibers, PDMS, a solder component, quartz, carbon fiber, thermally insulating particles, thermally conductive particles, ferromagnetic particles, barium titonate particles, or radar absorbing particles. The conductive particles may be selected from the group including silver powder, silver flakes, silver nanowires, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, or graphene. The functional filler may include a plurality of particles and an average diameter of the polymer particles may be at least one order of magnitude smaller than an average diameter of the functional filler particles.

A porous substrate may be disposed on the build surface, and a yield stress of the deposited composite waterborne dispersion may allow spanning over gaps in surface pores of the substrate. The porous substrate may include a textile. The textile may be selected from the group consisting of a woven textile or a knit fabric. The substrate may include a non-planar surface.

The method for three-dimensionally printing an object may further include scanning a non-planar surface with at least one of a laser distance sensor, a laser line scanner, or a ccd camera, to obtain a surface map of the topology of the surface, and then using the surface map to control deposition of the waterborne dispersion on the non-planar surface while maintaining a substantially constant standoff.

The waterborne dispersion may be deposited onto a substrate disposed on the build surface. A starting geometry of the printed object may be adapted to shrink into a desired shape, to thereby compensate for shrinkage of the deposited composite waterborne dispersion. The waterborne dispersion may be deposited onto a compliant substrate on the build surface and shrinkage of the deposited composite waterborne dispersion may drive a shape change in the compliant substrate. An object may be formed by the three-dimensionally printing the object with the composite waterborne dispersion.

The description of elements of the embodiments of other aspects of the invention may be applied to this aspect of the invention as well.

In another aspect, embodiments of the invention relate to a composite waterborne dispersion for 3D printing. The composite waterborne dispersion includes a composition including a first aqueous dispersion of polymer particles, an associative thickener, and a first functional filler including fumed silica, milled glass fibers, polydimethylsiloxane (PDMS), eutectic metal particles, carbon fiber, thermally insulating particles, thermally conductive particles, ferromagnetic particles, particles with high acoustic impedance, low-k dielectric particles, or high-k dielectric particles. The composition has a yield stress >0 Pa, the yield stress being at least one of a dynamic yield stress and a static yield stress. The composition is film-forming when dried.

One or more of the following features may be included. The composition may include at least 20 vol % of the first functional filler. The first functional filler may include eutectic metal particles, e.g., tin bismuth, gallium-indium, or indium-silver particles. The first functional filler may include thermally insulating particles, such as foams, aerogels, or hollow spheres. The first functional filler may include thermally conductive particles, e.g., boron nitride particles or diamond particles. The first functional filler may include ferromagnetic particles, such as carbonyl iron, ferrite, or molypermalloy powder. The first functional filler may include particles with high acoustic impedance, such as tungsten, alumina, zirconia, tungsten carbide or lead oxide particles. The first functional filler may include low-k dielectric particles, e.g., polytetrafluoroethylene PTFE, polyimide aerogel particles, and glass. The first functional filler may include high-k dielectric particles, such as titanium dioxide, strontium titanate, barium strontium titanate, barium titanate, or calcium copper titanate. The first functional filler may include fumed silica. The first functional filler may include milled glass fibers. The first functional filler may include polydimethylsiloxane (PDMS). The first functional filler may include an elastomer. The first functional filler may include carbon fiber.

The description of elements of the embodiments of other aspects of the invention may be applied to this aspect of the invention as well.

### BRIEF DESCRIPTION OF THE DRAWINGS

FIG. 1 is a schematic drawing of ink system interactions;

FIGS. 2A-2B are graphs illustrating the rheology of a silver conductive ink formulation in terms of static yield stress, in accordance with embodiments of the invention;

FIGS. 3A-3B are graphs illustrating the rheology of a silver conductive ink formulation in terms of dynamic yield stress, in accordance with embodiments of the invention;

FIGS. 4A-4B are graphs illustrating the rheology of a silver conductive ink formulation demonstrating pseudoplasticity in terms of shear rate and viscosity, in accordance with embodiments of the invention;

FIGS. 5A-5C are graphs illustrating the rheology of various ink formulations (to which an oscillation amplitude of increasing strain is applied) in terms of elastic modulus G′ and loss modulus G″ in accordance with embodiments of the invention;

FIGS. 6A-6B are plots of ink resistance vs time (ambient cure), in accordance with an embodiment of the invention;

FIG. 7 is a plot of ink resistivity vs cure temperature (two hour cure), in accordance with an embodiment of the invention;

FIG. 8 illustrates 3D printing of an inductive charging coil, in accordance with an embodiment of the invention;

FIGS. 9A-9E illustrate silver conductive ink stacking and spanning performed in accordance with embodiments of the invention; and

FIGS. 10A-10B illustrate inks printed onto porous textiles in accordance with embodiments of the invention.

### DETAILED DESCRIPTION

Printing ink in 3-dimensions places a certain set of demands on the ink rheology. 3D printed inks are designed to have a yield stress and therefore be self-supporting, allowing the ink to remain stable for months in a cartridge without settling or need for remixing. Repeatable extrusion of ink through a small orifice, such as a nozzle tip, demands that the material be highly shear-thinning, so that only a moderate applied pressure is required to extrude the ink through the orifice. Post-extrusion, the material's internal network is temporarily broken apart and viscosity is greatly reduced, requiring a fast recovery to its initial, self-supporting state. For certain applications, extending this recovery time may be advantageous (for example, a slow recovery obscures the appearance of discrete layers), but in general the recovery time is preferably minimal. A material that satisfies the above rheological criteria allows one to span gaps, build in 3D, and print closely spaced deposits of ink without overlap.

Accordingly, certain rheological properties are desired for 3D printing inks: (1) high static yield stress, which is the minimum stress required to initiate flow from a static, solid-like state; (2) pseudoplastic or shear-thinning behavior, which allows the ink to flow easily during extrusion from the nozzle; and (3) minimal thixotropy, meaning quick recovery time. In other words, the ink very quickly recovers the viscosity and yield stress that it had before it was sheared apart.

With the onset of increasingly strict volatile organic compounds (“VOC”) regulations, which limit the commercial usage of organic solvents, the market for waterborne polymer dispersions has flourished. Waterborne polymer dispersions are now used in a variety of applications ranging from paints to shoe manufacturing. Such commercial dispersions include polyurethanes, self-crosslinking polyurethanes, polycarbonate ester polyurethanes, acrylics, styrene acrylics, and self-crosslinking acrylics, just to name a few.

However, waterborne dispersions are low viscosity fluids, generally unsuitable for 3D printing on their own. While every interaction between components of an ink formulation—physical, chemical and/or electrostatic—strongly influences rheology, the list below describes certain ways of optimizing waterborne ink rheology for 3D printing:
Associative thickeners (AT) increase the viscosity, yield stress, and pseudoplastic and/or thixotropic behavior of the system. Possible interactions include: AT-AT, polymer-AT-polymer, particle-AT-particle, filler-AT-filler, polymer-AT-filler, etc.
Non-associative thickeners are polymers dissolved in solvent that thicken the system via polymer chain entanglement. The exclusive use of non-associative thickeners is generally not ideal for 3D printing applications requiring repeated start-stops, because non-associative thickeners cause ink “stringiness” and thus poor start-stop behavior. Such “stringiness” increases the likelihood of overlapping ink deposits (i.e., short circuits, if the ink is conductive) and undesirable protrusions from otherwise smooth surfaces. Furthermore, such thickeners generally display weak pseudoplastic behavior, which is not ideal for 3D printing. On the other hand, non-associative thickeners can be used to improve the ink's ability to print a continuous trace without break and support itself while spanning gaps in free space.
Pseudoplastic and/or thixotropic additives create a constructed 3D network that can be broken apart with shear. For example, fumed silica is composed of small particles that weakly flocculate and interact with each other mostly via surface interactions, i.e., hydrophobic interactions, hydrogen bonding, and van der Waals forces. The selection of fumed silica, including the choice of using a dispersion versus powder, is important for optimizing thixotropy, compatibility with the system, and optical clarity, if desired.
Other factors that influence rheology include: solids loading, solvent fraction, particle size, particle geometry, viscosity of polymer dispersion, amount of dispersant added, and surface chemistry of ink components.

The selection of one or more waterborne polymer dispersions depends on the desired application. For example, the formulation for a silver conductive ink requires that a selected polymer dispersion satisfy at least some of the following properties:
A narrow size distribution of small, well-dispersed and stabilized particles, at least 1 order of magnitude smaller than the conductive particles. Importantly, the dispersed polymer particles fill in the gaps between conductive particles as the ink dries. The preferred volume fraction of polymer in conductive ink is generally a trade-off between conductivity and improved mechanical properties of dried ink.
Freeze-thaw stability allows the formulated ink to withstand exposure to freezing temperatures multiple times without destabilizing. Such stability is important for commercial air shipping and extended storage.
Self-crosslinking results in the formation of a hard and flexible film with a room temperature cure.
Ability to be cured at elevated temperatures is beneficial, in case a post-processing condition is desired. For example, the conductive ink may be incorporated into crosslinking systems that require thermal curing to achieve final properties.

For a conductive ink to be successfully incorporated in 3D printed electronics, a number of demands are placed on the ink formulation:
High conductivity to minimize resistance of conductive traces.
Ability to fully cure and dry at room temperature, i.e., 22° C.
Low toxicity and odor, to be safely and easily handled by most users.
Low VOC content to satisfy industry regulations.
Strong adhesion to thermoplastics used in 3D printing such as polylactic acid (“PLA”), acrylonitrile butadiene styrene (“ABS”) and polyethylene terephthalate (“PET”).
Absence of air bubbles to ensure that no unintended break in printing could result in an open circuit.
Good flexibility of dried ink traces—if a printed electronic part is dropped and the conductive traces are brittle, there is a high risk of a broken trace, resulting in an open circuit.
Good abrasion resistance of dried ink traces to minimize visible scratching.
Ability to be 3D printed, following the ideal rheological properties. For conductive inks in particular, “non-stringiness” is highly desirable in preventing accidental overlap of traces (i.e., short circuits), and ink adhesion should be good for both electronic components and thermoplastic substrates.

While proper selection of a polymer dispersion is important to the success of a silver conductive ink, a number of other ingredients are typically added to the formulation to improve material properties:
Coalescents, i.e., slow-evaporating solvents that are miscible with water, may be added to optimize the rate at which the ink cures, reduce the risk of ink drying/clogging in the printing nozzle, and improve the final mechanical properties of dried ink.
Surfactants stabilize both the polymer dispersion and conductive particles within the uncured ink, ensuring long-term storage stability.
Defoamer destroys existing air bubbles and minimizes the formation of new air bubbles. The existence of air bubbles not only results in lower conductivity (air is an insulator), but also a single air bubble can ruin a print by causing an unintended break in printing a conductive trace, which results in an open circuit.
Adhesion promoter significantly improves adhesion to both PLA and electronic components. Without proper adhesion, there is a high risk of dried ink delaminating from a thermoplastic substrate and electronic components falling out of place in the circuit, both of which would result in print failure.

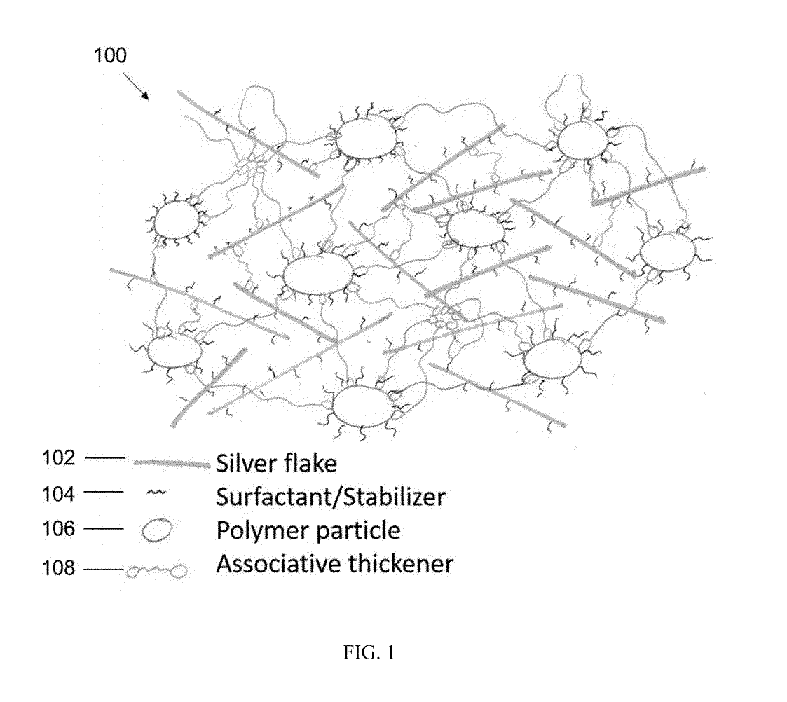

Referring to FIG. 1, typical physical and chemical interactions in silver conductive ink 100 are illustrated, i.e., between silver flakes 102, a surfactant 104, polymer particles 106, and an associative thickener 108. An associative thickener is a tri-block co-polymer with hydrophobic ends and hydrophilic middle. The silver flakes have a hydrophobic surface, and the polymer dispersion is moderately hydrophobic. If one were to make a mixture of the polymer dispersion, silver flake, and dispersant, then the dispersant would disperse the silver flakes very well in the polymer dispersion. However, since the silver flakes do not interact with the polymer dispersion, they would gradually settle to the bottom due to gravity. When the associative thickener is added to the mixture, the middle of the triblock co-polymer allows it to be dissolved into the aqueous medium. The hydrophobic ends cling to the surfaces of the silver flake, and the surfaces of the polymer dispersion, and also interact with themselves to form micelles. The interactions are mixed with some bridging polymer to particle, some bridging flake to flake, and some bridging flake to polymer, and some bridging either flake or polymer to micelles of the thickener itself. All these interactions create a linked 3D network that mechanically holds the silver flakes from settling out of solution, and gives the ink a yield stress that makes it printable.

Tuning the rheology of conductive ink is important for 3D printing. However, rheology modification requires particular care, because the addition of too much thickener or other additives can cause significant reductions in conductivity:
HEUR associative thickeners (hydrophobically modified polyurethanes) are water-soluble polymers with hydrophobic end groups, which physically interact with each other and create a branched network within the ink. The strength of physical interactions with dispersed polymer particles and conductive particles depend largely on the surface chemistry of the particle surfaces—stronger interactions increase the viscosity of the ink. The highly desirable HEUR thickener increases pseudoplastic behavior and long-term storage stability without adversely affecting conductivity, flexibility and hardness of deposited ink after room temperature cure, as long as the quantity of thickener is optimized.
Defoamers not only prevent/eliminate air bubble formation, but also some induce a pronounced thickening effect, which is important for designing a self-supporting ink. Such defoamers typically contain a combination of hydrophobic solids, polysiloxanes, and amorphous silica.
Conductive particles affect rheology, especially since they compose such a high volume fraction in conductive ink. Although rheology is not the most critical factor in selection of conductive particles, it should be noted that higher aspect ratio particles demonstrate more thixotropy and shear thinning behavior. Particle size and surface chemistry also affect rheology, in particular the possible addition of a fatty acid coating on the conductive particle surface.
Pseudoplastic/thixotropic additives such as fumed silica and carbon black reduce conductivity, but small amounts can significantly improve shape retention, pseudoplasticity and thixotropy of the ink. For applications that incorporate a mixing nozzle for 3D printing of gradient features, fumed silica and/or carbon black may be incorporated to vary conductivity.

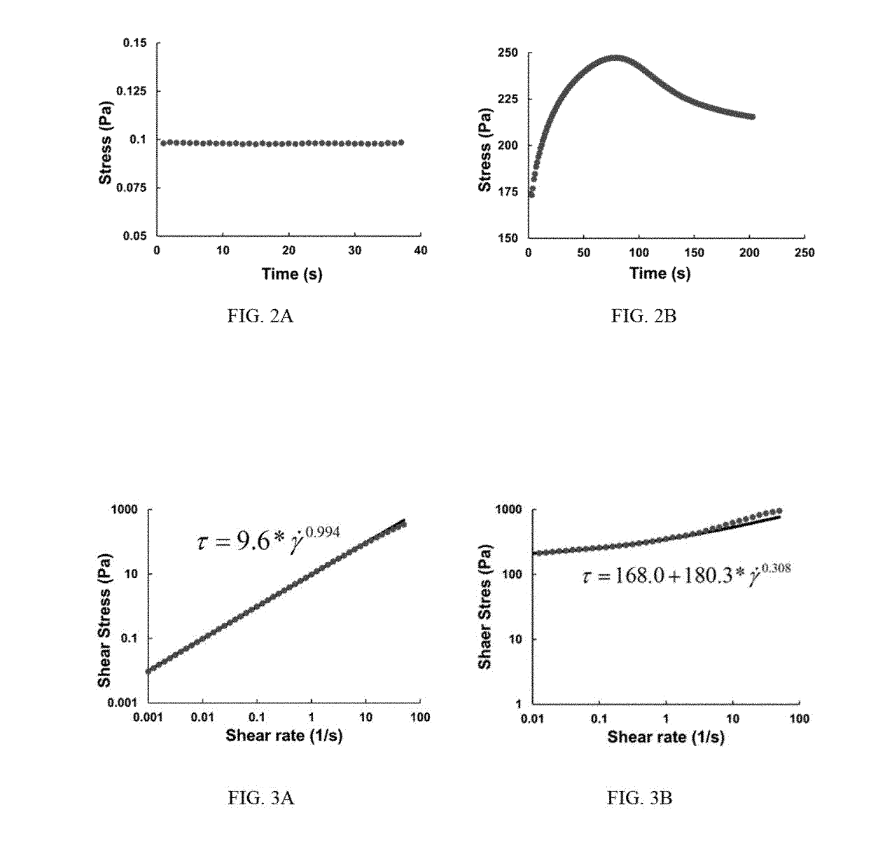

Referring to FIGS. 2A and 2B, graphs illustrate the rheology of a silver conductive ink formulation in terms of static yield stress. Using a TA Instruments DHR-3 Hybrid rheometer, and a vane and cup attachment, a constant shear rate of 0.01 l/s was applied to (2A) a silver conductive ink composition before silver particles were added, and (2B) a silver conductive ink composition after dispersion of silver particles. Static yield stress is defined as the minimum stress required to initiate flow in a material. In FIG. 2A, the shear stress remains constant over time, with no clear yield stress, as the strain is increased, whereas in FIG. 2B, when silver particles are incorporated, the stress increases with strain until reaching the static yield stress of about 250 Pa, subsequently dropping as the internal structure of the ink is sheared apart in the yielding event. In summary, the presence of the conductive particles and their interaction with the associative thickener is integral to obtaining a suitable non-zero static yield stress. Although associative thickener on its own may suitably thicken a conductive ink formulation, in reality only a small amount can be added without adversely affecting conductivity. However, because the silver particles interact strongly with the hydrophobic segments of the associative thickener, a static yield stress is created with minimal thickener addition, e.g., 0.5 to 1.5 wt %.

Referring to FIGS. 3A and 3B, graphs illustrate the rheology of a silver conductive ink formulation in terms of dynamic yield stress. A flow sweep of increasing shear rate was applied to (3A) conductive ink composition before silver particles are added, and (3B) silver conductive ink composition after dispersion of silver particles. Dynamic yield stress is defined as the minimum stress required to maintain flow in a material, and is generally lower in value than the static yield stress. The value of a dynamic yield stress is generally obtained by model fitting, i.e., by fitting a shear stress versus shear strain curve to a standard rheological model that has dynamic yield stress as one of the variables.

Rheological curve fitting software, Trios, may be used to fit a curve to the raw data shown in FIGS. 3A and 3B. Using an algorithm, multiple different rheology equations are attempted to be fit to the raw data. The goodness of fit is determined by the equation and parameters that produce a coefficient of determination with the value closest to 1. Curve fitting dictates that the best fitting model for the data in both FIGS. 3A and 3B is the Herschel-Bulkley model for a non-Newtonian fluid:

τ=τ₀+k\dot{γ}ⁿ

where τ is the shear stress, \dot{γ} is the shear rate, τ₀ is the dynamic yield stress, k is the consistency index, and n is the flow index. The dynamic yield stress τ₀ is the y-intercept of the curve, or the stress level below which the material can no longer flow. The shear rate \dot{γ} is the x variable, and the variable that is gradually modulated to study the behavior of the stress with shear rate. The dynamic yield stress is measured as the lowest stress reading recorded during the time period when the rheometer is moving at its lowest shear rate possible, thus causing the material to flow at a very slow rate. The dynamic shear rate is usually recorded through model fitting to rheological models with controlled strain rate (FIGS. 3A-3B). The static yield stress is recorded by gradually increasing the stress to measure when the material starts to flow (FIGS. 2A-2B).

The Hershel-Bulkley model is frequently used for shear thinning materials with a non-zero yield stress. When the yield stress term, τ₀, equals zero and the flow index term, n, equals one, the equation for the Herschel-Bulkley model reduces to Newton's law of viscosity, which may be used to describe a Newtonian fluid like water. Curve fitting analysis demonstrates that the model that best fits the data in FIG. 3A is the Hershel-Bulkley model with a yield stress value of zero.

Since the equation shown in FIG. 3A has a flow index close to one, this fluid model closely follows Newton's law with slight non-Newtonian behavior. The data in FIG. 3B also fits the Hershel-Bulkley model with a dynamic yield stress value (i.e., a y-intercept) that is greater than zero, and a flow index that is less than 1. This indicates that the material has a non-zero yield stress, and non-Newtonian flow. Curve fitting estimates the dynamic yield stress to have values of 0 Pa and 168 Pa for FIGS. 3A and 3B, respectively. Analysis was conducted over three decades in the range of 10⁻² to 1 Pa. Thus, it was demonstrated that the addition of silver particles increases the dynamic yield stress. One who is skilled in the art would readily ascertain which models are most likely to fit based on the fluid characteristics of the material of interest.

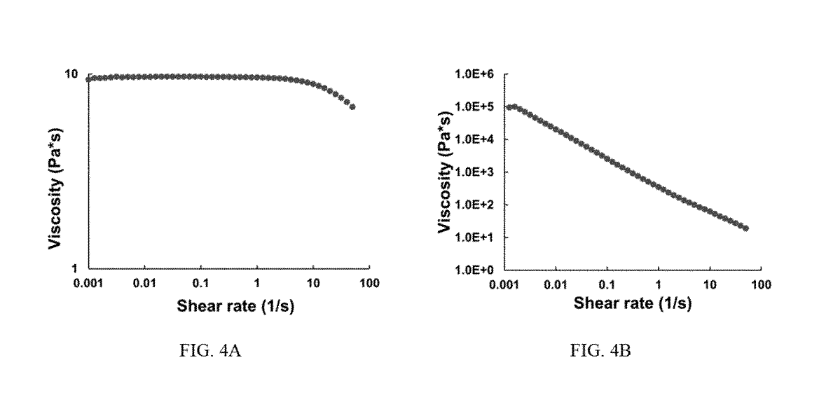

Referring to FIGS. 4A and 4B, a controlled shear rate flow sweep shown may be used to demonstrate shear thinning behavior, in which the viscosity of a non-Newtonian fluid decreases with increasing shear rate. Graphs (4A) and (4B) represent data for a conductive ink before silver particles are added, and silver conductive ink after dispersion of silver particles. For a range of shear rates 10⁻³ to 50 l/s, the viscosity in (4A) decreases by only 3 Pas, whereas the viscosity in (4B) decreases by more than three orders of magnitude. Thus, it was demonstrated that the addition of silver particles intensifies shear-thinning behavior.

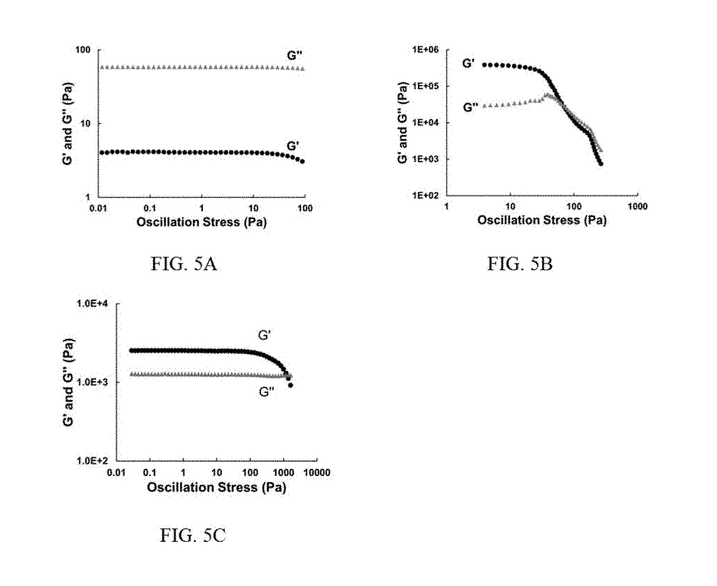

Referring to FIGS. 5A-5C, an oscillation amplitude sweep of increasing strain was applied to (5A) conductive ink before silver particles are added, (5B) silver conductive ink, and (5C) optically translucent ink, which contains a high percentage of associative thickener to thicken the latex dispersion, as well as some fumed silica. Viscoelastic behavior may be described by the storage modulus G′ and loss modulus G″. A solid-like material will display a dominant G′ value, while a fluid-like material will display a dominant G″ value. When a solid-like material reaches the yield stress, the storage modulus G′ begins to drop significantly. The point at which G′ and G″ cross over marks the transition from a solid-like to fluid-like state. It can be seen that without the presence of the dispersed silver particles in the ink formulation, the storage modulus is always lower than the loss modulus, indicating that the mixture is always liquid like, as evident in (5A). Graph (5B) demonstrates that the dispersion of silver particles and their interaction with other ink components cause the ink to behave elastically at low stress, until it reaches the yield point and converts to a liquid like medium. However, it is possible to create a viscoelastic ink with a much broader elastic range without the presence of silver particles, using primarily associative thickener and small quantities of fumed silica. In (5C), it is shown that such an ink has a dominant G′ until it begins to yield at a value of 225 Pa.

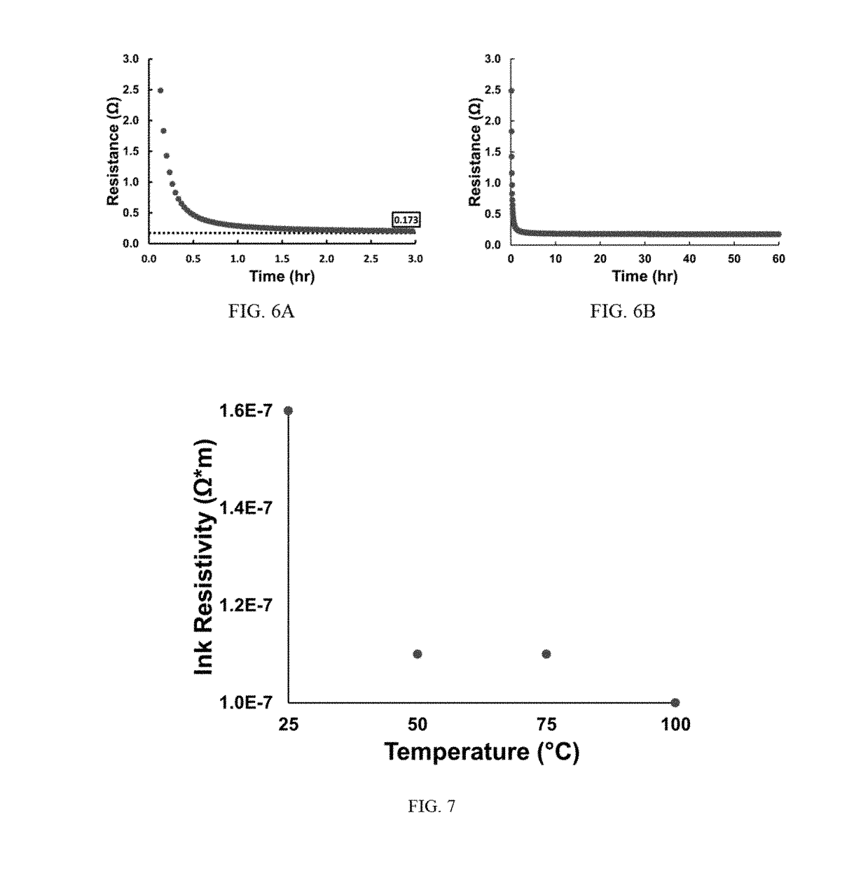

The ink formulation of an exemplary 3D printable, silver conductive ink is provided in Table 1, and was used for the preparation of the plots in FIGS. 6A-6B and FIG. 7,

TABLE 1
Ink formulation of an exemplary 3D
printable, silver conductive ink

| | Active component | | |
|---|---|---|---|
| | weight percent (%) | | |
| | Min- | Max- | |
| Chemical | imum | imum | Typical |
| Silver flake (d50~3.5 microns) | 5 | 90 | 78.3 |
| Polymer dispersion: SANCURE 843C | 4 | 15 | 5.6 |
| from Lubrizol | | | |
| HEUR Thickener: COAPUR 975W | 0.05 | 1 | 0.2 |
| from Coatex | | | |
| Silicone-based defoamer: BYK-1719 | 0.01 | 3 | 0.2 |
| from BYK | | | |
| Dispersant 1: HYDROPALAT WE | 0.01 | 3 | 0.1 |
| 3320 from BASF | | | |
| Dispersant 2: ZETASPERSE 3100 | 0.01 | 3 | 0.2 |
| from Air Products & Chemicals | | | |
| Coalescent: DOWANOL DPnB from Dow | 0.1 | 3 | 0.4 |
| Silane-based adhesion promoter: | 0.01 | 3 | 0.6 |
| (3-Glycidyloxypropyl)trimethoxysilane | | | |
| Deionized water | 10 | 30 | 14.4 |

This exemplary formulation in accordance with embodiments of the invention demonstrated the following material capabilities:
Self-supporting after deposition to build 3D circuits without short circuiting;
Quickly became conductive at room temperature within a short time frame, reaching 50% of its final conductivity within 30 minutes and 95% of its conductivity within 12 hours;
Ambient curing resulted in low volume resistivity (<2.3*10⁻⁷ Ω*m after 24 hours), and elevated curing resulted in even lower volume resistivity (1.1*10⁻⁷ Ω*m after 2 hours at 50° C.);
Abrasion: pencil hardness of dried ink at ambient cure improved from 5B to 2B over time, and elevated curing (2 hours at 75° C.) improved the pencil hardness to >4H (ASTM D3363-05); and
Low VOC content (<7%).

An alternative formulation of 3D printable, silver conductive ink is provided in Table 2:

TABLE 2
An alternative formulation of 3D printable, silver conductive ink

| | Active Component | | | |
|---|---|---|---|---|
| | Weight Percent | | | |
| Chemical | Minimum | Maximum | Typical | Weight |
| Polymer dispersion: | 0.1% | 40% | 3.8% | 37.879 g |
| flexible polyurethane | | | | |
| dispersion-Sancure | | | | |
| 12929 from Lubrizol | | | | |
| Polymer dispersion: | 0% | 40% | 14.3% | 142.945 g |
| a self-cross-linking | | | | |
| polyurethane dispersion- | | | | |
| Sancure 843C | | | | |
| from Lubrizol | | | | |
| Dispersant: | 0% | 2% | 0.25% | 2.533 g |
| ZETASPERSE3100 | | | | |
| from Air Products | | | | |
| & Chemicals | | | | |
| Dispersant: | 0% | 2% | 0.2% | 2.049 g |
| HYDROPALAT WE | | | | |
| 3320 from BASF | | | | |
| HEUR Thickener: | 0.05% | 5% | 1.2% | 11.622 g |
| COAPUR 975W | | | | |
| from Coatex | | | | |
| Silicone-based | 0% | 5% | 0.14% | 1.374 g |
| defoamer: | | | | |
| BYK-1719 from BYK | | | | |
| Coalescent: DOWANOL | 0% | 10% | 0.02% | 0.240 g |
| DPnB from Dow | | | | |
| AgC-A Silver flake | 60% | 99% | 80.0% | 797.959 g |

This alternative formulation yields an ink with good adhesion properties and improved flexibility. For example, experimental data indicated that the adhesion value improved from an initial value of 3, to a value of 5, after incorporating Sancure 12929. This data is based on ASTM D3359—Tape adhesion test, with the adhesion values being unitless grades assigned in accordance with the standards put forth in ASTM D3359.

Referring to FIGS. 6A and 6B, the conductivity of a silver conductive ink formulated in accordance with an embodiment of the invention (composition provided in the table above) was tracked over time at ambient cure, using a four point probe. The film was cast at approximately a 50 micron thickness, and the final resistivity of the ink trace was ˜1.4 e-7 Ω*m. A conductivity profile over a three-hour period is shown in FIG. 6A, and a conductivity profile over a 60-hour period is shown in FIG. 6B. The ink appeared to cure almost completely after one hour.

The same conductive ink was also exposed to elevated curing temperatures, and resistivity measurements were taken as shown in FIG. 7. Films were cast with a thickness of approximately 50 microns, and films were exposed at given temperatures for two hours. It appears that the silver conductive ink cures to near completion at 50° C. for two hours.

Ink formulations for 3D printing may vary widely. General criteria for 3D printing inks, based on composite waterborne polymer dispersions, are discussed below.

A conductive ink in accordance with some embodiments of the invention is a composite waterborne dispersion for 3D printing, including a composition of a first aqueous dispersion of polymer particles, an associative thickener, and a first functional filler including conductive particles. The composition has a yield stress >0 Pa, the yield stress being at least one of a dynamic yield stress and a static yield stress. In addition, the composition is film-forming when dried. A composition having a non-zero yield stress is advantageous for 3D printing of layers.

As discussed in detail below, in some embodiments of the invention, the first functional filler may be a material other than conductive particles. The following characteristics of the composition are applicable to various embodiments of the invention, including to compositions with fillers other than conductive particles.

The composition may have a static yield stress over 50 Pa, preferably over 100 Pa, and more preferably over 200 Pa, e.g., 240 Pa. The composition may have a dynamic yield stress of over 50 Pa, preferably over 100 Pa, e.g., 160 Pa or more preferably even higher, e.g., greater than 200 Pa. Higher yield stress enables particles to remain suspended in the dispersion for greater periods of time without settling. The high yield stress also allows one to build consecutive layers in printing without the bottom layer sagging from the stress caused by the weight of the layers on top.

The composition may have a viscosity ranging from 10 to 10,000 PA·s at a shear rate of 1/s. For some applications, the viscosity is preferably 100-1000 Pas, and even more preferably 200-500 Pas, e.g., 352 Pas. A higher viscosity allows one to keep fillers suspended for longer periods of time without settling.

The composition may include a non-volatile content of 70 wt % to 95 wt %, e.g., 87.5 wt %. In some embodiments, the composition may include a non-volatile content of greater than 25 volume percent, and more preferably greater than 40 vol % volume percent. A higher non-volatile content reduces shrinkage, due to a smaller volumetric change.

A maximum agglomerate size of the composition may be less than 50 microns. More preferably the maximum agglomerate size is as small as the largest particles present in the system. Preferably, the maximum agglomerate size is less than one-tenth of the diameter of the nozzle through which the waterborne dispersion is extruded, more preferably less than one-hundredth of the nozzle diameter. For example, for applications in which the waterborne dispersion is extruded out of a 250 micron nozzle, a maximum agglomerate size is preferably less than 20 microns. For extrusion of compositions of silver nanoparticles through even smaller nozzles, agglomerate sizes of less than 200 nm may be preferred.

The aqueous dispersion of polymer particles is film-forming at room temperature, i.e., at 22° C. The aqueous dispersion of polymer particles may have a minimum film formation temperature below 22° C. In some embodiments the polymer particles may also be self-crosslinking at room temperature, indicating that they form chemical bonds between particles during the process of coalescence as the water evaporates from the system.

A number of parameters may be considered for selecting appropriate polymer particles for inclusion in the aqueous dispersion. These parameters include mechanical properties suitable for the intended use, cost, compatibility with the chemistry of the functional filler, particle size, and film strength. Accordingly, the aqueous dispersion of polymer particles may include polyurethane, an acrylic, an alkyd, PVC, styrene butadiene, vinyl acetate, vinyl acetate ethylenes, vinyl maleate, and/or vinyl versatate. Examples of suitable acrylics include a styrene acrylic, a vinyl acrylic, a self-crosslinking acrylic, an epoxy-functionalized acrylic, hybrid alkyd-acrylic, and vinyl versatate acrylic. Examples of suitable polyurethanes include a self-crosslinking polyurethane, a polycarbonate ester polyurethane, an epoxy-functionalized polyurethane, and hybrid alkyd-polyurethane.

The associative thickener may be, e.g., a hydrophobically modified ethoxylated urethane (HEUR), an epoxy-functionalized polyurethane, epoxy-functionalized acrylic, an alkyd, a hybrid alkyd-acrylic, an hybrid alkyd-polyurethane, a hydrophobically modified alkali swellable emulsion (HASE), a tri-block co-polymer, a hydrophobically modified polyacrylate thickener, a hydrophobically modified polyether thickener, and a hydrophobically modified cellulose ether.

The composite waterborne dispersion may include a solid metal precursor and/or a dissolved metal precursor. The metal precursor is reduced to a solid metal filler during evaporation of the dispersion. An exemplary composition including silver acetate that functions as a metal precursor is:
Non-ionic polymer dispersion—binder
Water—solvent
Silver acetate—silver salt that dissolves in water
Ammonium hydroxide—forms diaminesilver (I) complex in water
Formic acid—reducing agent that is complexed with extra ammonia to form ammonium formate in solution

When the water evaporates, the amine evaporates from silver complex, and formate complex, the formic acid then reduces the silver precursor into elemental silver. At the same time, the evaporation of the water drives coalescence of the polymeric particles. The composition may include a second functional filler, such as a color pigment, preferably about 0.1-10 wt % color pigment.

In some embodiments, the second functional filler may be conductive particles, fumed silica, milled glass fibers, PDMS, eutectic metal particles, quartz, carbon fiber, thermally insulating particles, thermally conductive particles, thermally insulating particles, polyimide aerogels, ferromagnetic particles, and/or radar absorbing particles.

The second functional filler may include conductive particles of a type different from the conductive particles of the first functional filler, e.g., silver powder, silver flakes, silver nanowires, silver nanoribbons, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, graphene, copper oxide particles, tungsten particles, aluminum microparticles, nickel microparticles, or microparticles of eutectic metal systems. The second functional filler may also be a solder component, i.e., a component of a eutectic system that melts and changes phases when heated.

At least a portion of the second functional filler may include a coating material that interacts with the associative thickener. This interaction between the coating material and the associative thickener is typically a hydrophobic interaction. Associative thickeners for water-based systems almost always have hydrophobic end groups that “modify” the hydrophilic water soluble backbone. This allows the thickener to be soluble in water, but it will also interact with everything that is hydrophobic or hydrophobically-modified, including itself. For example, the conductive particles may also have some hydrophobic functionalization, interacting with the associative thickener and greatly enhancing the thickening effect.

The coating material may be, e.g., an unsaturated hydrocarbon, a fatty acid, an ionic surfactant, a nonionic surfactant, an ionic polymer, and/or a block copolymer. In some embodiments, the composite waterborne dispersion may be uncoated, and the outside may be ionized to electrostatically repel each polymer particle from other polymeric particles, to prevent agglomeration.

The composition may include at least 20 wt % conductive particles. The conductive particles may be, e.g., silver powder, silver flakes, silver nanowires, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, and/or graphene.

In some embodiments, the conductive particles may be silver flakes having a tapped density of 2.7-3.9 g/cm³, a diameter range of 3-10 microns, and a specific surface area of 0.6-1.2 m²/g.

An average diameter of the polymer particles in the aqueous dispersion is preferably at least one order of magnitude smaller than an average diameter of the conductive particles of the first functional filler, although larger particles can be effective in some cases.

The composition may also include a rheological modifier that increases a resting viscosity, yield stress, and pseudoplastic behavior of the composition. Resting viscosity is also referred to as “zero shear viscosity.” Higher yield stress enables particles to remain suspended in the dispersion for greater periods of time without settling. The high yield stress also allows one to build consecutive layers in printing without the bottom layer sagging from the stress caused by the weight of the layers on top.

The composition may further include at least one of a defoamer, an antifoam, a coalescent, a dispersant, and an adhesion modifier.

As used herein, antifoam prevents the formation of foam, and a defoamer eliminates existing foam. The defoamer may be, e.g., a silicone-based defoamer, an oil-based defoamer, a powder-based defoamer, a wax-based defoamer, polyethylene glycol-based defoamer, polypropylene glycol-based defoamer, an alkyl-polyacrylate based defoamer, an antifoam, PDMS, polyester-functionalized silicone, and/or fluorosilicone.

The composition may include the coalescent. The coalescent serves to slow the evaporation rate of solvent in the composite waterborne dispersion, lower the minimum film formation temperature, and aid in the coalescence of polymer particles, thereby improving film formation. The coalescent may be a glycol ether, (3-hydroxy-2,2,4-trimethylpentyl) 2-methylpropanoate (TEXANOL from Eastman), propylene carbonate, diethyl carbonate, N-Methyl-2-pyrrolidone (NMP), dimethyl formamide (DMF), tetrahydrofuran (THF), dibasic esters, glycols, glycol ether acetates, propylene glycol, ethylene glycol, 2,2,4-trimethyl-1,3-pentanediol diisobutyrate (OPTIFILM enhancer 300 from Eastman), OPTIFILM enhancer 400, 2-ethylhexyl benzoate (VELATE 368 Coalescent from Eastman) or 2,2,4-trimethyl-1,3-pentanediol diisobutyrate (VELATE 375 Coalescent). Suitable glycol ethers may be dipropylene glycol n-butyl ether, diethylene glycol monomethyl ether, diethylene glycol n-butyl ether, dipropylene glycol monomethyl ether, and 2-butoxyethanol (a glycol ether).

The composition may include the dispersant, and the dispersant may be, e.g., sorbitan monooleate (SPAN 80 from Sigma Aldrich), polyethylene glycol sorbitan monooleate (TWEEN 80), octylphenol ethoxylate triton X-100, HYDROPALAT WE 3320 (from BASF, trade secret: NJTSRN 489909-5554-PC; one component is a type of fatty alcohol alkoxylate), DAPRO W-77 from Elementis Specialties (contains ethylene glycol monobutyl ether, ethyl alcohol, and dioctyl sodium sulfosuccinate), JEFFSPERSE X3503 from Huntsman (proprietary blend), DISPERBYK 190 from BYK (solution of a high molecular weight block copolymer with pigment affinic groups), ZETASPERSE 3100 from Air Products & Chemicals (proprietary surface active polymers), RHODOLINE 3500, DISPEX Ultra FA 4480 NU from BASF (modified fatty alcohol polyglycol ether), ionic surfactants such as sodium stearate or sodium dodecylbenzene sulfonate, a non-ionic surfactant such as polyethylene ethoxylate, or a comb polymer.

The composition may include an adhesion modifier, and the adhesion modifier may be, e.g., a silane coupling agent, a secondary polymer, a secondary polymer dispersion, a dissolved polymer, an oligomer, a surfactant, a wetting agent, a chlorinated polyolefin, an epoxy-functionalized compound, and/or an amino-functional silicone polymer.

The adhesion modifier may include the silane coupling agent and the composition may include 0.01-3 wt % silane coupling agent.

The adhesion modifier may include the silane coupling agent and the silane coupling agent may be, e.g., glycidoxypropyltrimethoxysilane, aminopropyltriethoxysilane, aminoethylaminopropyl-trimethoxysilane, 3-methacryloxypropyltrimethoxysilane, cationic vinylbenzyl and amino-functional methoxy-silane, vinyltrimethoxysilane, or aminoethylaminopropyltrialkoxysilane. In some embodiments, the adhesion modifier may include at least two different types of silane coupling agents.

The adhesion modifier may include a second aqueous dispersion of a second type of polymer particles. The polymer particles of the second aqueous dispersion may be compatible with the polymer particles of the first aqueous dispersion. The particles are compatible in that the second aqueous dispersion does not destabilize the first dispersion or vice versa. Also, the resulting film does not phase separate into two different region e.g., polymer 1 and polymer 2.

The adhesion modifier may include a dissolved polymer. The dissolved polymer may be a cellulose derivative, such as hydroxypropyl cellulose, hydroxyethyl cellulose, hydroxypropylmethyl cellulose, and/or sodium carboxy methyl cellulose.

Alternatively, the water soluble polymer may be an ionic polymer, such as polyacrylic acid, alginate, polyvinyl alcohol, polyacrylamide, xanthan gum, pectin, carrageenan, and/or hyaluronic acid. In some embodiments, the dissolved polymer may be a nonionic polymer such as polyvinylpyrrolidone, polyethylene glycol, polyethylene oxide, dextran, guar gum, and/or chitosan.

The composition may cure and dry at room temperature, i.e., at 22° C. Accordingly, the composition may be used without a heating/curing step.

Instead of (as well as in addition to) the conductive particles included in the conductive inks discussed above, composite waterborne dispersions suitable for 3D printing may include other functional fillers. For example, in an alternative embodiment, an ink is a composite waterborne dispersion for 3D printing, including a composition of a first aqueous dispersion of polymer particles, an associative thickener, and a functional filler. The composition has a yield stress >0 Pa, the yield stress being at least one of a dynamic yield stress and a static yield stress. In addition, the composition is film-forming when dried.

In compositions in accordance with embodiments of the invention, the polymer dispersion is the binder, the associative thickener makes it printable, and the filler carries out the function. Many different polymer dispersions may be used to achieve the same purpose. However, in the case of silver ink, the associative thickener significantly affects the viscosity by interacting with the hydrophobic silver flake. In the case where the functional filler is not hydrophobic, one may choose a polymer dispersion that is more hydrophobic so that the associative thickener provides more thickening without the need for the filler to provide any thickening. In some cases, the filler may contribute to thickening; in such embodiments, the amount of filler may be tuned to accommodate for the thickening.

The functional filler may be selected to provide particular material properties and advantages; the composition may include at least 20 vol % of the functional filler.

The functional filler may be fumed silica, which may increase the mechanical strength and abrasion resistance, as well as improve the rheological properties of the ink for printing.

The functional filler may be milled glass fibers, which may increase the mechanical strength and the stiffness of the cured film.

The functional filler may be polydimethylsiloxane (PDMS), which may make the film more compliant and tough. The addition of PDMS and/or other elastomer particles may also increase the level of acoustic attenuation of the film.

The functional filler may be eutectic metal particles. The inclusion of eutectic particles allows the formulation of an ink that is liquid metal at low temperatures, but quickly solidifies upon cooling. An ink including eutectic particles may be conductive and may be sinterable at low temperatures. Suitable eutectic metal particles may be tin-bismuth, gallium-indium, indium-silver, etc.

The functional filler may be carbon fiber, which increases the mechanical strength and the stiffness of the cured film.

The functional filler may be thermally insulating particles, which shield heat and provide insulation. Suitable thermally insulating particles may be materials containing greater than 30 vol % air, for example, foams, aerogels, hollow spheres, etc., including glass bubbles and polyimide aerogel particles.

The functional filler may be thermally conductive particles, which transmit heat. An ink containing thermally conductive particles may be used to print a heat sink, heat spreader, or matrix for high power carrying conductors. Suitable thermally conductive particles may be particles with thermal conductivities greater than 5 W/mK, for example, boron nitride or diamond.

The functional filler may be ferromagnetic particles. Inks containing ferromagnetic particles may be used to create inductors, motor cores, etc. These ferromagnetic or inducting particles may also be radio frequency (RF) and/or electromagnetic absorbers, which may be used to reduce or stop signal interference and/or noise. Suitable ferromagnetic particles may be carbonyl iron, ferrite, molypermalloy powder, etc.

The functional filler may be particles with high acoustic impedance, which may be used to tune the acoustic impedance of an interface to selectively allow sound or ultrasound to pass through or be reflected by the interface. Suitable particles with high acoustic impedance may be a high density material such as tungsten, alumina, zirconia, tungsten carbide, or lead oxide particles.

The functional filler may be low-k dielectric particles, which may be used to tune the dielectric constant of an ink for RF applications. Low-k dielectric particles may have a dielectric constant less than 2.75. Suitable low-k dielectric particles may be polytetrafluoroethylene (PTFE), polyimide aerogel particles, or glass.

The functional filler may be high-k dielectric particles, which may be used to tune the dielectric constant of an ink for RF applications. Suitable high-k dielectric particles may be barium titanate, strontium titanate, titanium dioxide, barium strontium titanate, or calcium copper titanate.

Generally, any of the previously described aqueous dispersion of polymer particles and associative thickener may be used in combination with these functional fillers, with some customization. For example, the dispersions for the conductive ink indicated above are preferred because they have a small particle size, and are flexible, tough, and self cross-linking. In other situations, another polymer dispersion may be ideal. For example, if high flexibility is desired, a styrene acrylic may be preferred. If low cost is desired, then an acrylic dispersion may be selected. If electrical percolation is not a concern, then a larger particle size polymer dispersion may be chosen for better mechanical properties and greater shelf stability. If bonding to an epoxy matrix is desired, then one may use a dispersion of solid epoxy, such that it can chemically bond to the substrate.

An exemplary formulation for a 3D printable polyamide aerogel ink is given in Table 3.

TABLE 3
Exemplary formulation for a 3D printable polyamide aerogel ink.

| | Active Component | | | |
|---|---|---|---|---|
| | Weight Percent | | | |
| Chemical | Minimum | Maximum | Typical | Weight |
| Dispersant: Turboset | 50 | 99 | 71.8 | 11.577 g |
| Ultra Pro, a polyurethane | | | | |
| waterborne dispersion | | | | |
| from Lubrizol | | | | |
| Deionized water | 0 | 20 | 4.4 | 0.709 g |
| Dispersant: | 0 | 4 | 1 | 0.171 g |
| ZETASPERSE 3100 | | | | |
| from Air Products | | | | |
| & Chemicals | | | | |

Speed-mix for 30 s at 1500 without vacuum

| | | | | |
|---|---|---|---|---|
| Dispersant: | 0 | 4 | 0.85 | 0.137 g |
| HYDROPALAT | | | | |
| WE 3320 from BASF | | | | |
| HEUR Thickener: | 0.1 | 10 | 3.5 | 0.571 g |
| COAPUR 975W | | | | |
| from Coatex | | | | |
| Silicone-based defoamer: | 0 | 5 | 0.85 | 0.137 g |
| BYK-1719 from BYK | | | | |
| Coalescent: DOWANOL | 0 | 25 | 1.5 | 0.240 g |
| DPnB from Dow | | | | |

Speed mix for 3 minutes at 1500 without vacuum

| | | | | |
|---|---|---|---|---|
| Thermal insulating | 0 | 50 | 12.4 | 2 g |
| functional filler | | | | |
| polyimide aerogel | | | | |
| powder | | | | |
| Treated or untreated silica: | 0 | 10 | 3.5 | 0.571 g |
| TS-720 or Ultrabond 4740 | | | | |

Speed mix for 30 s at 800 and 1 minutes at 1500

This exemplary formulation has a low dielectric constant and is thermally insulating.

3D Printing of Composite Waterborne Dispersions

Any of the composite waterborne dispersions discussed herein may be used in three-dimensional printing e.g., direct-write. Broadly, an object may be three-dimensionally printed by a three-dimensional printer that includes (i) a dispensing system having at least one cartridge adapted to dispense a composite waterborne dispersion through an orifice as a continuous filament, (ii) a build surface disposed below the dispensing system, and (iii) a robotic control system. An example of a suitable three-dimensional printer is the Voxel8 Developer's Kit, available from Voxel8, Inc., Somerville, Mass. The composite waterborne dispersion is dispensed from the cartridge through the orifice to deposit the waterborne dispersion onto the build surface to define at least a portion of the object. The composite waterborne dispersion includes a composition of an aqueous dispersion of polymer particles and an associative thickener. The composition has a yield stress >0 Pa, the yield stress being at least one of a dynamic yield stress and a static yield stress. The composition is film-forming when dried.

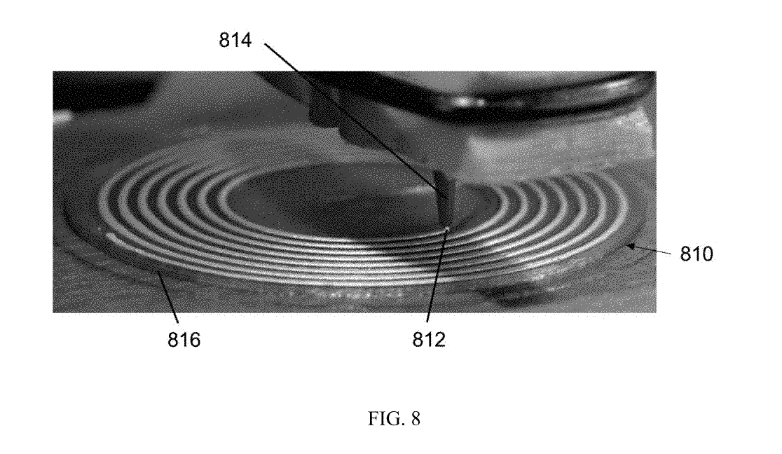

Referring to FIG. 8, 3D printing of an inductive charging coil 810 is illustrated. In particular, conductive ink 812 including a composite waterborne dispersion in accordance with embodiments of the invention, is shown being pneumatically deposited through a 250 micron nozzle 814 to form an inductive charging coil 810 embedded inside of a 3D printed plastic substrate 816 using a 3D printer.

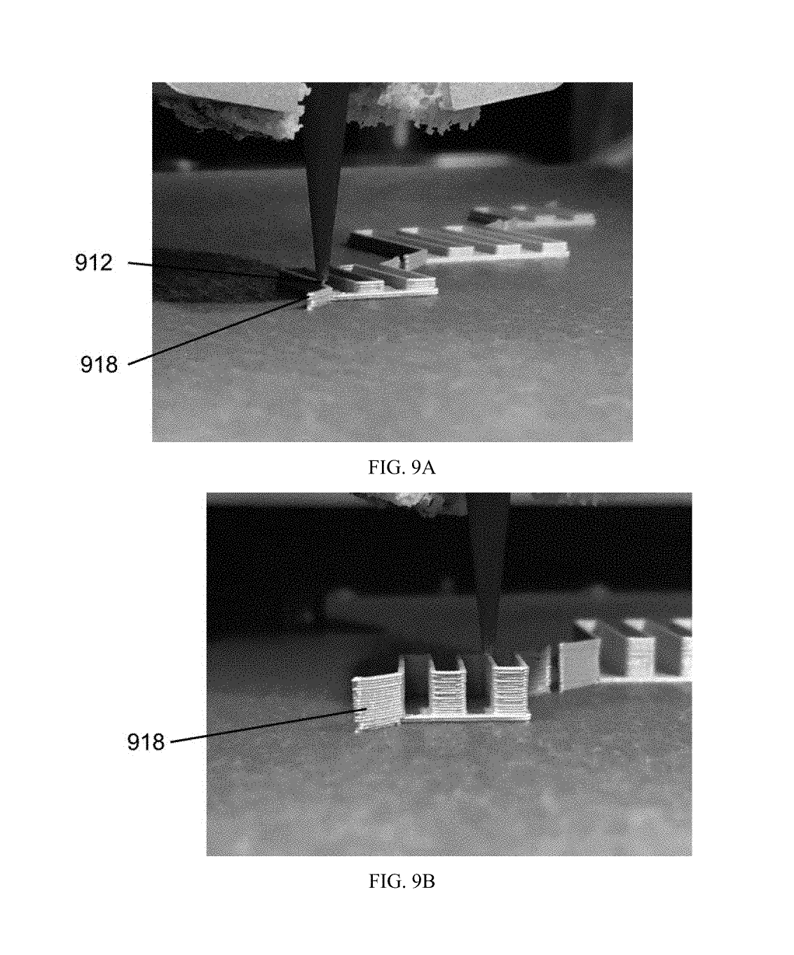

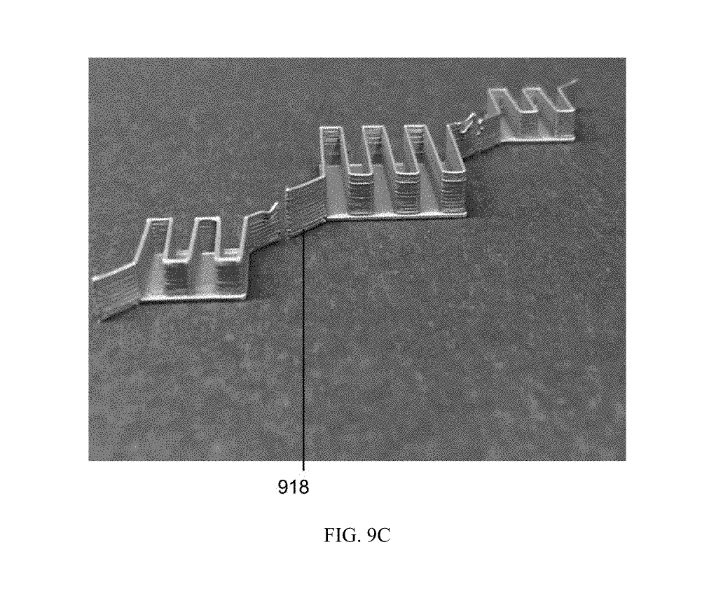

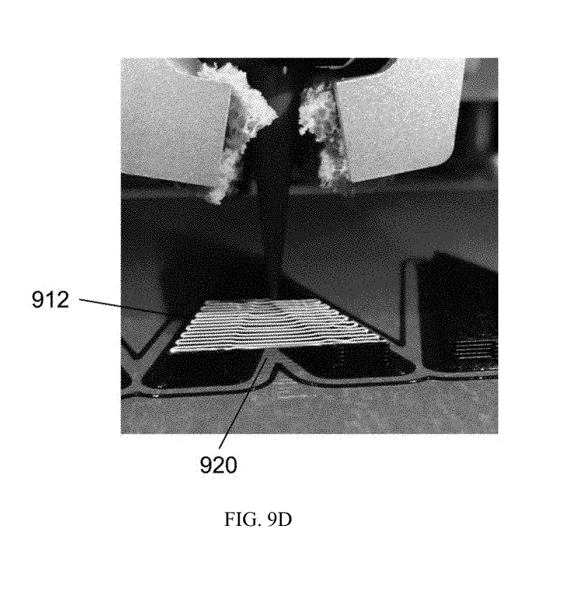

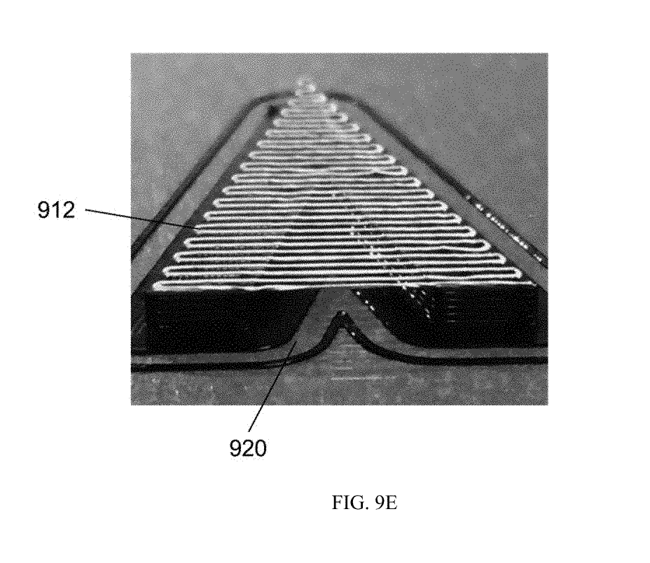

Referring to FIGS. 9A-9E, composite waterborne dispersions in accordance with embodiments of the invention may be used for 3D printing. In particular, FIGS. 9A-9C demonstrate that silver conductive ink 912 including a composite waterborne dispersion may be extruded to form stacked layers 918, and FIGS. 9D-9E show that silver conductive ink 912 can span across gaps 920 as wide as 9 mm.

The composition may also include a functional filler, such as a color pigment, conductive particles, fumed silica, milled glass fibers, PDMS, a solder component, quartz, carbon fiber, thermally insulating particles, thermally conductive particles, ferromagnetic particles, and/or radar absorbing particles.

Exemplary suitable conductive particles are silver powder, silver flakes, silver nanowires, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, and graphene.

The functional filler may include a plurality of particles, such that an average diameter of the polymer particles is at least one order of magnitude smaller than an average diameter of the functional filler particles. This size difference allows silver flakes to lay flat without being perturbed by large polymeric particles.

A porous substrate may be disposed on the build surface, or act as the build surface itself, and a yield stress of the deposited composite waterborne dispersion allows spanning over gaps in surface pores of the substrate. The porous substrate may be a textile, e.g., a woven textile or a knit fabric. The substrate may have a non-planar surface, such as a shoe upper.

The non-planar surface may be scanned with a laser distance sensor, a laser line scanner, and/or a ccd camera, to obtain a surface map of the topology of the surface. Then surface map may then be used to control deposition of the waterborne dispersion on the 3D surface while maintaining the nozzle at approximately a constant distance or standoff from the 3D surface.

In some embodiments, the waterborne dispersion may be deposited onto a substrate that is disposed on the build surface. A starting geometry of the printed object may be adapted to compensate for shrinkage of the deposited composite waterborne dispersion. For example, if a cube shape was directly printed onto a rigid substrate, then the shrinkage from drying would cause the cube to shrink, but it would still be constrained by the substrate, causing the desired cube to turn into a trapezoidal prism like geometry with a base that has a larger area than the top surface. If the forces caused by shrinkage are modeled, then the starting geometry can be adjusted such that the dried and deformed shape resembles the initially desired form. For example, a trapezoidal prism with a base having a smaller area than the top surface could be printed, such that after shrinking, a cube is left. In some embodiments, the unavoidable shrinkage forces can be taken advantage of to drive a desired shape change. In particular, the waterborne dispersion may be deposited onto a compliant substrate on the build surface, and shrinkage of the deposited composite waterborne dispersion drives a shape change in the compliant substrate.

A particular application for 3D printing of composite waterborne dispersions lies in athletic shoe manufacturing, for which the yarn upper knit shoes includes polymer dispersions that were cast into a mold and hot-pressed onto the woven or knit surface. The polymer film serves as a stretchable, tough and breathable coating, satisfying the high demands of athletic wear. Although the rheological demands for 3D printing shoe uppers are substantially similar to 3D printing conductive traces in electrical circuits, certain requirements are unique:
The desired mechanical properties of the waterborne dispersion should be retained in the 3D printable ink, even with the addition of rheological modifiers.
Thixotropy can help reduce/eliminate the appearance of discrete printed layers
Optical clarity is generally required, greatly limiting the selection of rheological modifiers. Proper dispersion, small particle size, and closely matching refractive indices of polymer dispersion and additives is important. Select HEUR thickeners and fumed silica powders and/or dispersions may preserve the ink's transparency.
The ink formulation should be non-toxic and low VOC.
Ink shrinkage should be controlled so that any 3D shape may be reliably printed.
Ink “breathability” or superb moisture vapor transmission is important in allowing the ink to fully cure at every layer in a timely manner, without air bubble formation.

An exemplary formulation for optically clear ink for shoe uppers is listed in Table 4.

TABLE 4
Exemplary formulation for optically clear ink for shoe uppers

| | Active component | | |
|---|---|---|---|
| | weight percent (%) | | |
| Chemical | Minimum | Maximum | Typical |
| Polymer dispersion: IMPRANIL | 30 | 45 | 38.0 |
| DLC-F from Covestro, an | | | |
| ionic/anionic polycarbonate | | | |
| ester polyurethane dispersion | | | |
| HEUR Thickener: | 0.5 | 1.0 | 0.7 |
| COAPUR 975W from Arkema | | | |
| Fumed silica: | 0 | 1.5 | 1.0 |
| AEROSIL 1 R972 from | | | |
| Evonik, which acts | | | |
| as a rheological modifier. | | | |
| Deionized water | 50 | 70 | 60.3 |

An alternative embodiment of an optically clear ink for textile coating is shown in Table 5.

TABLE 5
Alternative embodiment of an optically clear ink for textile coating

| | Active Component | | | |
|---|---|---|---|---|
| | Weight Percent | | | |
| Chemical | Minimum | Maximum | Typical | Weight |
| Polymer dispersion: Turbo- | 50 | 99 | 91.4 | 36.584 g |
| set Ultra Pro, an aqueous | | | | |
| polyurethane dispersion | | | | |
| HEUR Thickener: | 0.1 | 10 | 3.8 | 1.524 g |
| Optiflo H7500 | | | | |
| HEUR Thickener: | 0.1 | 10 | 3.8 | 1.524 g |
| COAPUR 975W | | | | |
| from Coatex | | | | |
| Fumed silica: | 0 | 10 | 0.9 | 0.364 g |
| AEROSIL 1R972 | | | | |
| from Evonik | | | | |

An alternative embodiment of a black ink for textile coating is shown in Table 6.

TABLE 6
Alternative embodiment of a black ink for textile coating.

| | Active Component | | | |
|---|---|---|---|---|
| | Weight Percent | | | |
| Chemical | Minimum | Maximum | Typical | Weight |
| Polymer dispersion: | 50 | 99 | 0.95 | 5.976 g |
| Turboset Ultra Pro | | | | |
| HEUR associative | 0.1 | 10 | 3.95 | 0.249 g |
| thickener: Optiflo H7500 | | | | |
| Carbon Black: Mogul E | 0 | 10 | 0.52 | 0.033 g |
| Dispersant: HYDROPALAT | 0 | 5 | 0.52 | 0.032 g |
| WE 3320 from BASF | | | | |

The above embodiments of inks for textile coating are capable of spanning large gaps and may be used in applications such as coating porous athletic shoes.

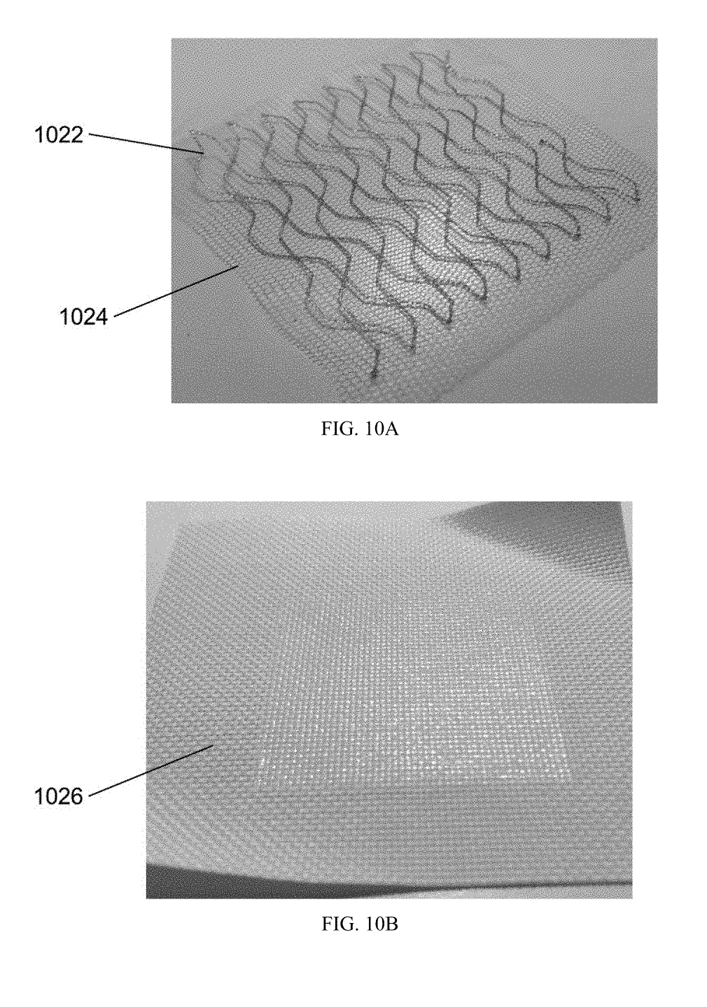

Referring to FIGS. 10A and 10B, composite waterborne dispersions in accordance with embodiments of the invention may be printed to form objects, e.g., by printing onto textiles. Accordingly, the resulting objects incorporate the composite waterborne dispersions. FIG. 10A shows a pigmented polyurethane dispersion 1022 printed onto an open polyester netted textile 1024. FIG. 10B shows a translucent polyurethane dispersion printed as a continuous film onto polyester canvas 1026.

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive. Various combinations and permutations of the materials and properties of the embodiments disclosed herein are considered to be taught, as well.

What is claimed is:

1. A composite waterborne dispersion for 3D printing, comprising:
a composition comprising
a first aqueous dispersion of polymer particles;
an associative thickener; and
a first functional filler comprising conductive particles,
wherein (i) the composition has a yield stress >0 Pa, the yield stress being at least one of a dynamic yield stress and a static yield stress, and (ii) the composition is film-forming when dried.

2-35. (canceled)

36. A method for three-dimensionally printing an object with a three-dimensional printer including (i) a dispensing system comprising at least one cartridge adapted to dispense a composite waterborne dispersion through an orifice, (ii) a build surface disposed below the dispensing system, and (iii) a robotic control system with at least one axis of movement, the method comprising:
dispensing the composite waterborne dispersion from the cartridge through the orifice to deposit the waterborne dispersion toward the build surface to define at least a portion of the object,
wherein the composite waterborne dispersion includes a composition comprising
an aqueous dispersion of polymer particles; and
an associative thickener; and
wherein (i) the composition has a yield stress >0 Pa, the yield stress being at least one of a dynamic yield stress and a static yield stress, and (ii) the composition is film-forming when dried.

37. The method of claim 36, wherein the composition further comprises a functional filler selected from the group consisting of a color pigment, conductive particles, fumed silica, milled glass fibers, PDMS, a solder component, quartz, carbon fiber, thermally insulating particles, thermally conductive particles, ferromagnetic particles, barium titanate particles, and radar absorbing particles.

38. The method of claim 37, wherein the conductive particles are selected from the group consisting of silver powder, silver flakes, silver nanowires, silver nanoparticles, silver-coated copper, silver-coated glass, silver-coated aluminum, gold nanowires, gold nanoparticles, gold powder, gold flakes, gold-coated copper, copper nanowires, copper microwires, copper nanoparticles, carbon nanotubes, carbon particles, and graphene.

39. The method of claim 38, wherein the functional filler comprises a plurality of particles and an average diameter of the polymer particles is at least one order of magnitude smaller than an average diameter of the functional filler particles.

40. The method of claim 36, wherein a porous substrate is disposed on the build surface, and a yield stress of the deposited composite waterborne dispersion allows spanning over gaps in surface pores of the substrate.

41. The method of claim 40, wherein the porous substrate comprises a textile.

42-48. (canceled)

49. A composite waterborne dispersion for 3D printing, comprising:
a composition comprising
a first aqueous dispersion of polymer particles;
an associative thickener; and
a first functional filler selected from the group consisting of fumed silica, milled glass fibers, polydimethylsiloxane (PDMS), eutectic metal particles, carbon fiber, thermally insulating particles, thermally conductive particles, ferromagnetic particles, particles with high acoustic impedance, low-k dielectric particles, and high-k dielectric particles,
wherein (i) the composition has a yield stress >0 Pa, the yield stress being at least one of a dynamic yield stress and a static yield stress, and (ii) the composition is film-forming when dried.

50. The composite waterborne dispersion of claim 49, wherein the composition comprises at least 20 vol % of the first functional filler.

51. The composite waterborne dispersion of claim 49, wherein the first functional filler comprises eutectic metal particles, and the eutectic metal particles are selected from the group consisting of tin bismuth, gallium-indium, indium-silver particles.

52. The composite waterborne dispersion of claim 49, wherein the first functional filler comprises thermally insulating particles, and the thermally insulating particles are selected from the group consisting of foams, aerogels, and hollow spheres.

53. The composite waterborne dispersion of claim 49, wherein the first functional filler comprises thermally conductive particles, and the thermally conductive particles are selected from the group consisting of boron nitride particles and diamond particles.

54. The composite waterborne dispersion of claim 49, wherein the first functional filler comprises ferromagnetic particles, and the ferromagnetic particles are selected from the group consisting of carbonyl iron, ferrite, and molypermalloy powder.

55. The composite waterborne dispersion of claim 49, wherein the first functional filler comprises particles with high acoustic impedance, and the particles with high acoustic impedance are selected from the group consisting of tungsten, alumina, zirconia, tungsten carbide, and lead oxide particles.

56. The composite waterborne dispersion of claim 49, wherein the first functional filler comprises low-k dielectric particles, and the low-k dielectric particles are selected from the group consisting of polytetrafluoroethylene PTFE, polyimide aerogel particles, and glass.

57. The composite waterborne dispersion of claim 49, wherein the first functional filler comprises high-k dielectric particles, and the high-k dielectric particles are selected from the group consisting of titanium dioxide, strontium titanate, barium strontium titanate, barium titanate, and calcium copper titanate.

58. The composite waterborne dispersion of claim 49, wherein the first functional filler comprises fumed silica.

59. The composite waterborne dispersion of claim 49, wherein the first functional filler comprises milled glass fibers.

60. The composite waterborne dispersion of claim 49, wherein the first functional filler comprises polydimethylsiloxane (PDMS).

61. The composite waterborne dispersion of claim 49, wherein the first functional filler comprises carbon fiber.
